(19) United States
(12) Patent Application Publication
(10) Pub. No.: US 2013/0024341 A1
(43) Pub. Date: Jan. 24, 2013

(54) METHOD AND APPARATUS FOR PROVIDING TRANSACTION RELATED SERVICE

(71) Applicants: Hee-chul JEON, Suwon-si (KR); Yong-gook Park, Yongin-si (KR); Tae-young Kang, Seoul (KR); Won-young Choi, Suwon-si (KR); Da-hye Park, Suwon-si (KR)

(72) Inventors: Hee-chul JEON, Suwon-si (KR); Yong-gook Park, Yongin-si (KR); Tae-young Kang, Seoul (KR); Won-young Choi, Suwon-si (KR); Da-hye Park, Suwon-si (KR)

(73) Assignee: Samsung Electronics Co., Ltd., Gyeonggi-do (KR)

(21) Appl. No.: 13/402,393

(22) Filed: Feb. 22, 2012

(30) Foreign Application Priority Data
Jul. 22, 2011 (KR) 10-2011-0073244

(51) Int. Cl. G06Q 20/32

(52) U.S. Cl. 705/35

(57) ABSTRACT

A method of providing a transaction related service is provided. The method includes receiving first payment method information corresponding to a store from a first device; comparing the first payment method information and second payment method information available for a user; and recommending the second payment method based on a result of the comparison.

### PRIORITY

This application claims priority under 35 U.S.C. §119(a) to Korean Patent Application No. 10-2011-0073244, filed on Jul. 22, 2011 in the Korean Intellectual Property Office, the entire disclosure of which is incorporated herein by reference.

### BACKGROUND OF THE INVENTION

1. Field of the Invention

The present invention relates generally to a method and apparatus for providing a transaction related service, and more particularly, providing a transaction related service recommending a suitable payment method to a user.

2. Description of the Related Art

Recently, companies have issued multiple mileage cards, discount cards, and other membership cards to maintain or encourage customer loyalty. Users carry such cards in their bags or wallets, and use them when needed, but it is inconvenient to carry multiple cards.

### SUMMARY OF THE INVENTION

The present invention provides a method and apparatus for providing a transaction related service for storing card information in a user terminal and selecting and recommending a suitable card to a user through a user terminal or store related server.

According to an aspect of the present invention, a method of providing a transaction related service is provided. The method includes receiving a first payment method information corresponding to a store from a first device; comparing the first payment method information and a second payment method information available for a user; and recommending the second payment method based on a result of the comparing.

According to another aspect of the present invention, a method of providing a transaction related service is provided. The method includes receiving a first payment method information available for a user from a first device; comparing the first payment method information and a second payment method information corresponding to a store; and recommending the first payment method based on a result of the comparing.

According to another aspect of the present invention, an apparatus for providing a transaction related service is provided. The apparatus includes a communicating unit for receiving a first payment method information corresponding to a store from a first device; a storage unit for storing a second payment method information available for a user; a controlling unit for recommending the second payment method based on a result of comparing the first payment method information and the second payment method information.

According to another aspect of the present invention, an apparatus for providing a transaction related service is provided. The apparatus includes a communicating unit for receiving a first payment method information available for a user from a first device; a storage unit for storing a second payment method information corresponding to a store; and a controlling unit for recommending the first payment method based on a result of comparing the first payment method information and the second payment method information.

### BRIEF DESCRIPTION OF THE DRAWINGS

The above and other features and advantages of the present invention will become more apparent by describing in detail embodiments thereof with reference to the attached drawings in which:

FIG. 1 is a diagram illustrating a system for providing a location-based service, according to an embodiment of the present invention;

FIG. 2 is a flowchart illustrating a method of providing a transaction related service, according to an embodiment of the present invention;

FIGS. 3A through 3C illustrate tables describing payment method information according to embodiments of the present invention;

FIGS. 4A through 4C illustrate a method of transmitting payment method information to a user terminal, according to embodiments of the present invention;

FIG. 5 illustrates tables describing first and second payment method information and a recommendation list, according to an embodiment of the present invention;

FIG. 6 is a flowchart illustrating a method of providing a transaction related service, according to another embodiment of the present invention;

FIGS. 7A and 7B are diagrams illustrating a method of determining and transmitting recommended payment method information to a user terminal, which is performed by a service server, according to embodiments of the present invention; and

FIG. 8 is a block diagram of a system for providing a transaction related service, according to an embodiment of the present invention.

### DETAILED DESCRIPTION OF THE INVENTION

The present invention will now be described more fully with reference to the accompanying drawings, in which embodiments of the invention are shown. As used herein, the term “and/or” includes any and all combinations of one or more of the associated listed items.

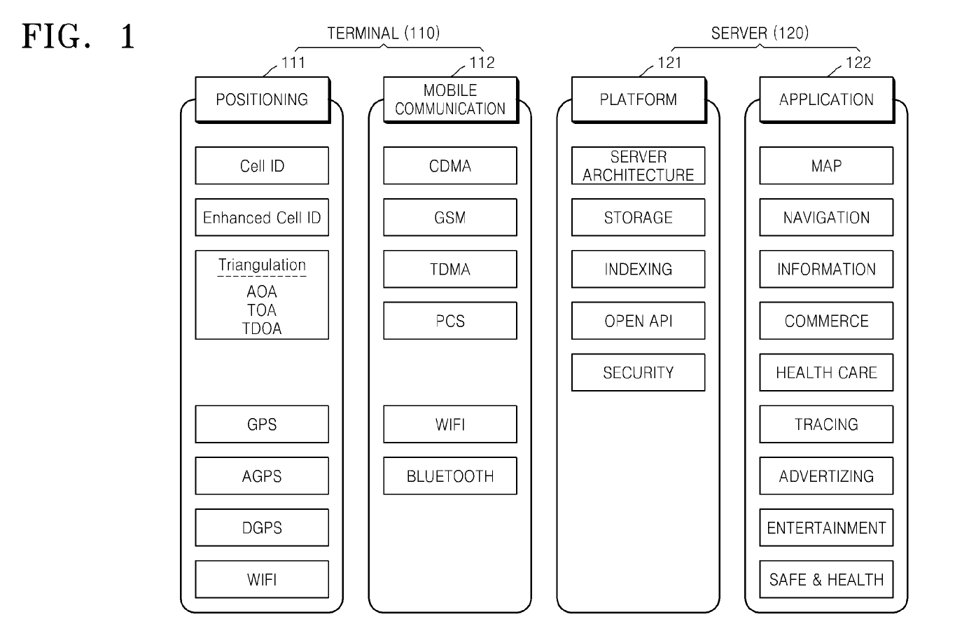

FIG. 1 is a diagram illustrating a system for providing a location-based service, according to an embodiment of the present invention.

The system includes a terminal 110 and a server 120. The terminal 110 includes a positioning module 111 and a mobile communication module 112, and the server 120 includes a platform 121 and an application 122.

The positioning module 111 is a module which checks a location of the terminal 110, and uses technology such as triangulation, e.g., cell IDentification (ID) positioning (Cell ID), Enhanced cell ID positioning (Enhanced Cell ID), Angle of Arrival (AoA), Time of Arrival (ToA), or Time Difference of Arrival (TDoA), Global Positioning System (GPS), Assisted GPS (AGPS), Differential Global Positioning System (DGPS), or Wireless Fidelity (WiFi). However, the positioning module 111 is not limited to the above technologies.

The mobile communication module 112 is a module enabling the terminal 110 and the server 120 to communicate with one another. Examples of technology related to mobile communication include Code Division Multiple Access (CDMA), global system for mobile communications (GSM), Time Division Multiple Access (TDMA), and Personal Communication Service (PCS), and examples of a technology related to local area communication include WiFi and Bluetooth, but examples are not limited to the above.

The platform 121 may include server architecture technology, storage technology, indexing technology, open Application Programming Interface (API) technology, and security technology. The server architecture technology is a location-based technology for responding to a location information request of the terminal 110 by obtaining a location from a location obtaining server, managing location information, processing location information of an individual or a group, and tracking a movement route. Storage technology is technology for storing and managing a large amount of information. Indexing technology is technology used for systemizing location information itself or information related to the location information into an optimized form and configuring the location information to be easily searched. The open API technology is technology related to providing location information and related information to another enterprise. The security technology regulates access, such as user profile management, certification, and security. However, the platform 121 is not limited to the above.

The application 122 provides a location-based service to the terminal 110. Examples of the application 122 include a map application, a navigation application, an information application, a commerce application, a health care application, a tracing application, an advertising application, an entertainment application, and a health and safety application, but are not limited thereto. The application 122 according to an embodiment may relate to a commerce application.

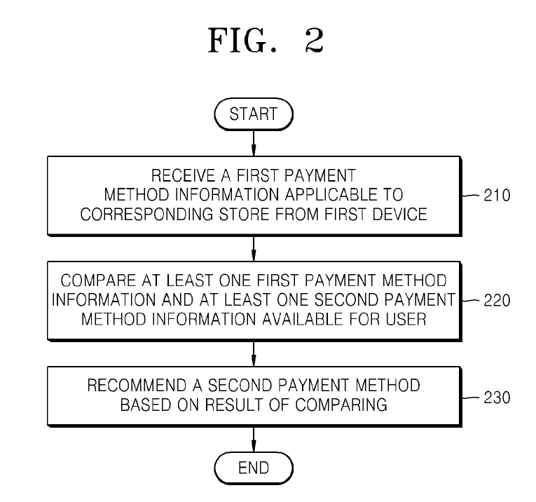

FIG. 2 is a flowchart illustrating a method of providing a transaction related service, according to an embodiment of the present invention.

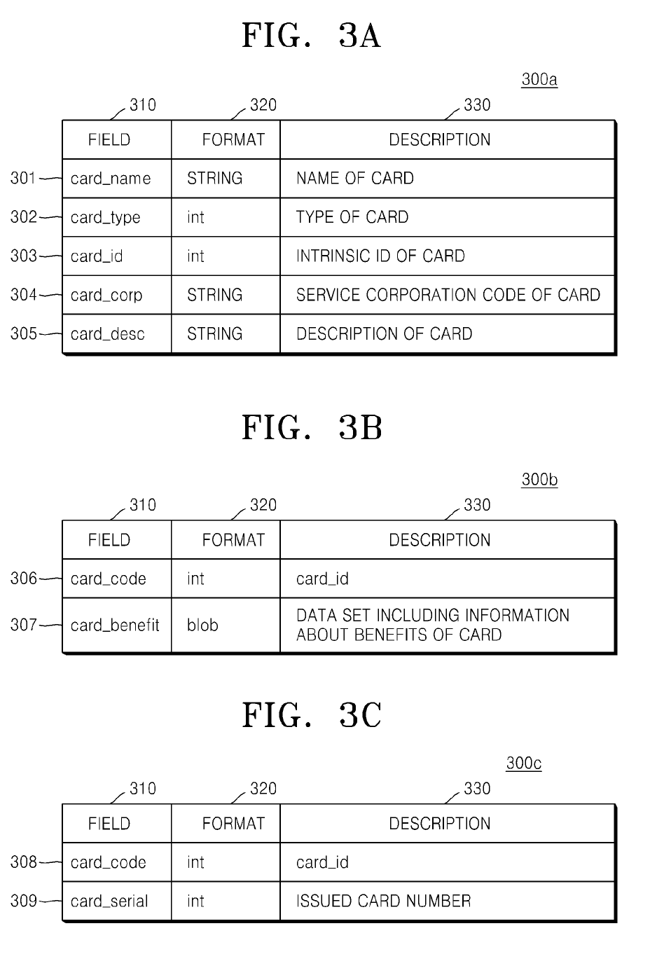

Referring to FIG. 2, an apparatus for providing a transaction related service receives at least one first payment method information corresponding to a store from a first device through a first network including at least one of wired communication and wireless communication, in step 210. According to an embodiment of the present invention, the apparatus may be a user terminal and the first device may be a service server. The service server is connected to a device related to the corresponding store, and stores payment method information which may be used in the corresponding store. The service server is connected to the device related to the corresponding store through a second network including at least one of wired communication and wireless communication. The first and second networks may be the same or different from one another. An example of the payment method information includes information related to a card for replacing an item having an exchangeable value, such as a credit card, a membership card, a mileage card, a point card, a coupon, a ticket, a voucher, an invitation ticket, or the like (hereinafter, referred to as a card), but is not limited to the above. According to an embodiment of the present invention, a first payment method is a payment method that may be used in the corresponding store. The service server may pre-receive and store the first payment method information from the device related to the corresponding store, or may pre-receive and store the first payment method information from a related external server. The payment method information will now be described in detail with reference to FIGS. 3A through 3C.

FIGS. 3A through 3C illustrate tables describing payment method information according to embodiments of the present invention. Data fields shown in FIGS. 3A through 3C are merely illustrative, and are not limited thereto.

FIG. 3A is a table showing information about a card stored in a card related server having information about general cards. The information 300a has a data structure including a field 310, a format 320, and a description 330. A card_name field 301 is in an string format and may indicate a name of a card. A card_type field 302 is in an int format and may include a type of a card, such as a credit card or point card. Also, a card_id field 303 is in an int format and may indicate an ID of a card. A card_corp field 304 is in a string format and may indicate a service corporation code of a card. A card_desc field 305 is in a string format and gives a description about a card.

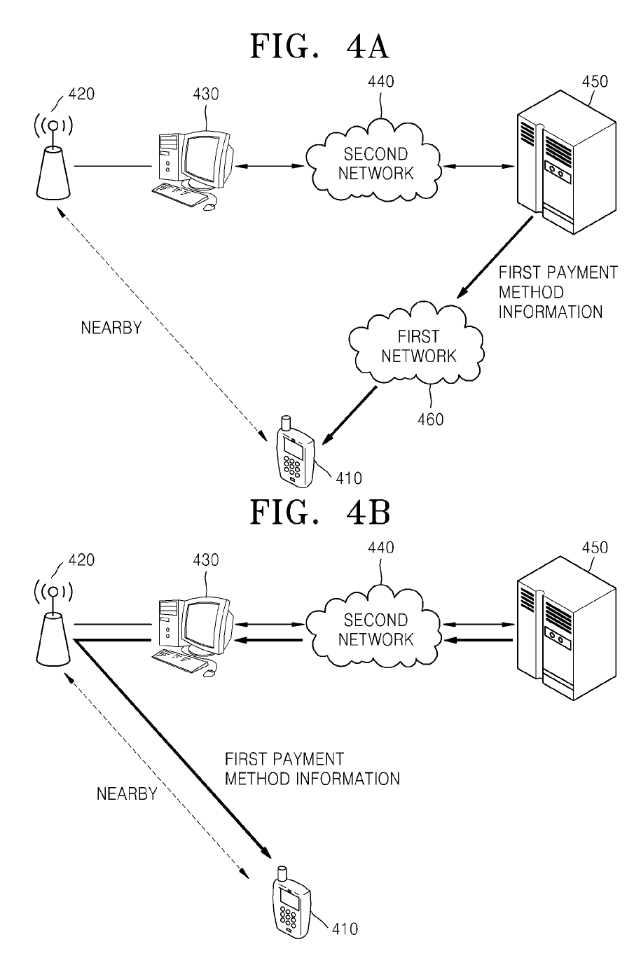

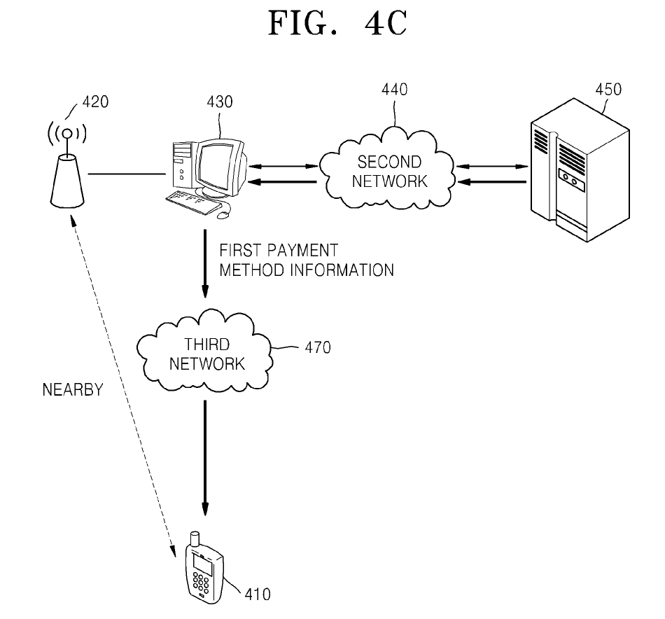

FIG. 3B is a table of payment method information stored in a service server that can be used in a corresponding store. The payment method information of FIG. 3B corresponds to first payment method information that will be described later with reference to FIGS. 4A through 4C. The payment method information 300b is a data structure of the field 310, the format 320, and the description 330. A card_code field 306 is in an int format and may indicate information about the card_id field 303 received from the card related server. Further, a card_benefit field 307 is in a binary large object (blob) format and may indicate a dataset including information about benefits of a card. The service server receives payment method information related to the corresponding store from a terminal related to the corresponding store, transmits the received payment method information to the card related server to receive the corresponding card_id field 303 from the card related server, thus generating and storing the card_code field 306. Moreover, the card_benefit field 307 may be extracted from the received payment method information related to the corresponding store, or it may be received from the card related server. Also, the card related server transmits the card_id field 303 and information about the benefits of a card directly to the service server based on the policy of a card company, and the service server may generate and store the card_code field 306 and the card_benefit field 307 based on the card_id field 303 and information regarding the benefits of a card.

FIG. 3C is a table showing payment method information stored in a user terminal and available for a user. The payment method information of FIG. 3C will be described later.

The user terminal may receive first payment method information when the user terminal is in close proximity to a second device connected to the service server. The second device may be a wireless transceiver (e.g., an Access Point (AP)) connected to the device related to the corresponding store. The second device may be embedded in the device related to the corresponding store. According to an embodiment of the present invention, examples of a method of communicating between the user terminal and the wireless transceiver include WiFi, Bluetooth, and a method of using any beacon sensor, but are not limited thereto. When the user terminal is within a tolerance field of the wireless transceiver including the second device, the wireless transceiver may recognize the user terminal via a predetermined checking process. For example, when an AP including the wireless transceiver is a passive type AP which performs a passive scanning, the AP transmits a beacon, the user terminal transmits an authentication request to the AP upon receiving the beacon, and the AP transmits an authentication response to the user terminal. Then, the user terminal transmits an association request to the AP, and the AP transmits an association response to the user terminal, and, thus, the user terminal and the AP are connected to one another. Furthermore, for example, when the AP including the wireless transceiver is an active type AP which performs an active scanning, the user terminal transmits a probe request to the AP and the AP transmits a probe response, and thus the user terminal and the AP are connected to one another via authenticating and connecting processes. The AP and the user terminal may be connected to one another by the device related to the corresponding store connected to the AP. When the user terminal and the AP are connected to one another, the wireless transceiver, and/or the device related to the corresponding store, transmits information about the presence of the user terminal to the service server. When the service server recognizes the presence of the user terminal, the service server transmits the first payment method information to the user terminal.

Alternatively, when the service server recognizes the presence of the user terminal, the service server may transmit the first payment method information to the device related to the corresponding store and the device related to the corresponding store may transmit the first payment method information to the user terminal through the wireless transceiver, instead of the service server directly transmitting the first payment method information to the user terminal.

In another alternative, upon receiving the first payment method information from the service server, the device related to the corresponding store may transmit the first payment method information through a third network including via wired communication or wireless communication instead of the wireless transceiver. The third network may be the same as or different from the first or second network.

Referring back to FIG. 2, in step 220, the user terminal compares the first payment method information with a second payment method information available for the user. The second payment method information is payment method information available for the user, which is stored on the user terminal. Examples of a second payment method are the same as those of the first payment method. The second payment method information is stored in the user terminal directly by the user or by receiving the second payment method information from an external server related to a payment method.

FIG. 3C is a table illustrating payment method information stored in a user terminal and available for a user. The payment method information of FIG. 3C corresponds to the second payment method information. The payment method information 300c also has a data structure including field 310, format 320, and description 330. A card_code field 308 is in an int format and may indicate information about the card_id field 303 received from the card related server. Also, a card_serial field 309 is in a string format and may indicate a card number of a corresponding card. The user terminal may generate and store the card_code field 308 and the card_serial field 309 by connecting to the card related server. In other words, the user terminal compares the card_code field 306 in the payment method information 300b of FIG. 3B and the card_code field 308 in the payment method information 300c of FIG. 3C.

Referring back to FIG. 2, the user terminal recommends a second payment method based on a result of the comparison in step 230. The user terminal classifies the second payment method information as matching the first payment method information, i.e., the same as the first payment method information, and recommends the second payment method information to the user according to a predetermined standard. Examples of the predetermined standard include a financial standard such as a high discount rate, a user purchase pattern standard, and a payment pattern standard, but are not limited thereto since the predetermined standard may differ based on the recommendation policy. Alternatively, the user terminal may prioritize and recommend a second payment method having high standard value. Referring to FIGS. 3B and 3C, when the card_code field 308 in the payment method information 300c including the second payment method information stored in the user terminal and the card_code field 306 in the payment method information 300b including the first payment method information are the same as one another, the user terminal may classify the second payment method information, analyze the card_benefit field 307 corresponding to the card_code field 306, and recommend a second payment method according to the predetermined standard.

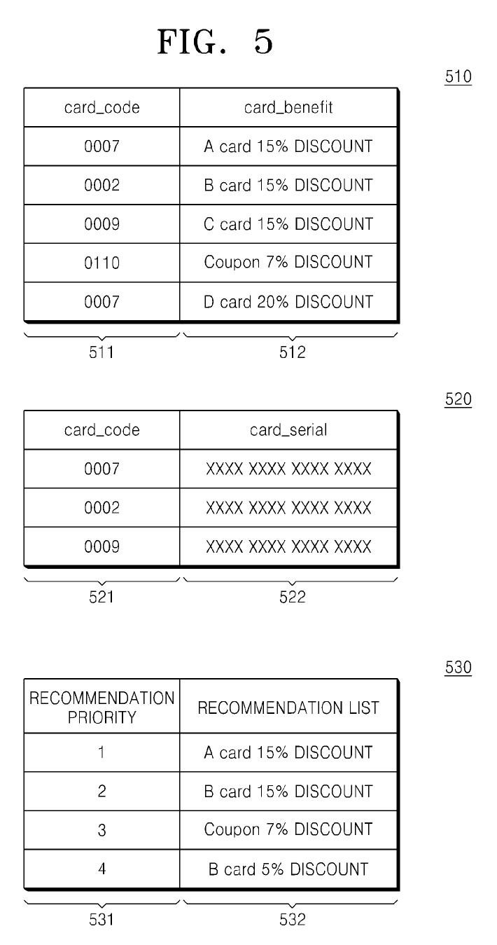

FIGS. 4A through 4C are diagrams illustrating a method of transmitting payment method information to a user terminal 410, according to embodiments of the present invention. FIG. 5 illustrates tables showing first and second payment method information and a recommendation list, according to an embodiment of the present invention.

Referring to FIG. 4A, when the user terminal 410 is in close proximity to a wireless transceiver 420, a device 430 related to a corresponding store and connected to the wireless transceiver 420 notifies a service server 450 that the user terminal 410 is connected through a second network 440. Then, the service server 450 directly transmits first payment method information to the user terminal 410 through a first network 460. For example, referring to FIG. 5, the service server 450 transmits first payment method information 510 to the user terminal 410 through the first network 460. The first payment method information 510 includes card_code information 511 related to a card ID and card_benefit information 512 related to card benefits. Upon receiving the first payment method information 510, the user terminal 410 compares the first payment method information 510 and the second payment method information 520 stored in the user terminal 410. The second payment method information 520 includes card_code information 521 related to a card ID and card_serial information 522 indicating a card number. Corresponding payment methods included in the card_code information 511 of the first payment method information 510 and the card_code information 521 of the second payment method information 520 may be a 0007 card, a 0002 card, and a 0009 card. A non-corresponding payment method that is available is a 0110 coupon. The user terminal 410 may classify payment methods and recommend a second payment method to a user based on the classification. A recommendation list 530 includes a recommendation list 532 recommended to the user with recommendation priority 531 based on a high discount rate. For example, the 0007 card is recommended first as the 0007 card has the highest discount rate of 15%.

Alternatively, referring to FIG. 4B, when the user terminal 410 is in close proximity to the wireless transceiver 420, the device 430 connected to the wireless transceiver 420 notifies the service server 450 that the user terminal 410 is connected through the second network 440. The service server 450 then transmits the first payment method information to the device 430 through the second network 440. The device 430 then transmits the first payment method information to the user terminal 410 through the wireless transceiver 420. For example, referring to FIG. 5, the device 430 transmits the first payment method information 510 received from the service server 450 to the user terminal 410 through the wireless transceiver 420. The first payment method information 510 includes the card_code information 511 and the card_benefit information 512. The user terminal 410 recommends a second payment method to the user, as described with reference to FIG. 4A.

Alternatively, referring to FIG. 4C, when the user terminal 410 is in close proximity to the wireless transceiver 420, the device 430 connected to the wireless transceiver 420 notifies the service server 450 that the user terminal 410 is connected through the second network 440. The service server 450 then transmits the first payment method information to the device 430 through the second network 440. The device 430 then transmits the first payment method information to the user terminal 410 through a third network 470, instead of through the wireless transceiver 420. For example, referring to FIG. 5, the device 430 directly transmits the first payment method information 510 received from the service server 450 to the user terminal 410. The user terminal 410 recommends a second payment method to the user, as described with reference to FIG. 4A.

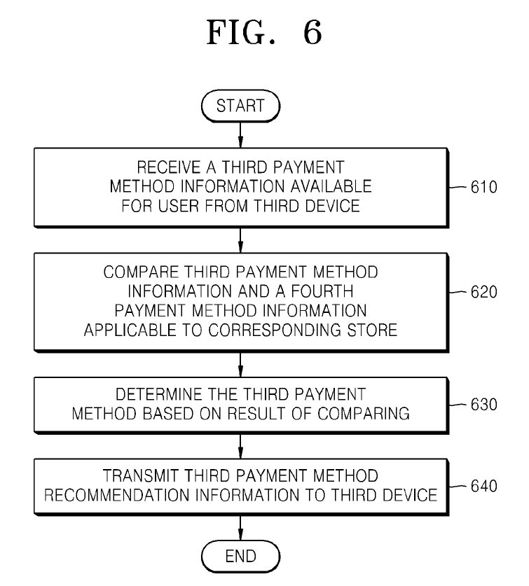

FIG. 6 is a flowchart illustrating a method of providing a transaction related service, according to another embodiment of the present invention. The method of FIG. 6 differs from the method of FIG. 2 in that a service server compares payment method information and recommends a payment method to a user based on a result of such comparison.

Referring to FIG. 6, a server for providing a transaction related service receives a third payment method information available for a user from a third device, in step 610. Unlike the method of FIG. 2, the apparatus will be referred to as a service server and the third device will be referred to as a user terminal in FIG. 6. The third payment method information may be the same as the second payment method information of FIG. 2. Accordingly, the information shown in FIG. 3C may correspond to the third payment method information. Further, fourth payment method information may be the same as the first payment method information of FIG. 2. Accordingly, details thereof will be omitted. The third payment method information is stored in the user terminal directly by a user or is received from an external server related to a payment method.

When the user terminal is in close proximity to a fourth device connected to the service server, the service server may receive the third payment method information from the user terminal. The fourth device may be the same as the second device of FIG. 2. More specifically, the fourth device may be a wireless transceiver (e.g., an AP) connected to a device related to a corresponding store. The fourth device may be embedded in the device related to the corresponding store. Examples of a method of communication between the user terminal and the wireless transceiver include WiFi, Bluetooth, and a method of using any beacon sensor, but the examples are not limited thereto. When the user terminal is within a tolerance field of the wireless transceiver including the fourth device, the wireless transceiver may recognize the user terminal via a predetermined determination process. For example, when an AP including the wireless transceiver is a passive type AP which performs a passive-scanning, the AP transmits a beacon, the user terminal transmits an authentication request to the AP upon receiving the beacon, and the AP transmits an authentication response to the user terminal. The user terminal then transmits an association request to the AP, and the AP transmits an association response to the user terminal, and, thus, the user terminal and the AP are connected to one another. When the AP is an active type AP which performs an active-scanning, the user terminal transmits a probe request to the AP and the AP transmits a probe response, and, thus, the user terminal and the AP are connected to one another via the authentication and connection processes. The AP and the user terminal may be connected to one another by the device related to the corresponding store connected to the AP. When the user terminal and the AP are connected to one another, the user terminal transmits the third payment method information to the service server through the wireless transceiver and/or the device related to the corresponding store. Alternatively, when the user terminal and the AP are connected to one another, the user terminal may transmit the third payment method information directly to the service server through a second network including at least one of wired communication and wireless communication.

In step 620, the service server compares the received third payment method information and at least one fourth payment method information applicable to the corresponding store. The service server is pre-connected to the device related to the corresponding store, and may pre-store the fourth payment method information the same as the first payment method information of FIG. 2. Accordingly, the information shown in FIG. 3B may correspond to the fourth payment method information. The service server may pre-receive and store the fourth payment method information from the device related to the corresponding store, or may receive and store the fourth payment method information from an external server related to the fourth payment method information. The service server is connected to the device related to the corresponding store through the second network including wired communication and wireless communication. The first and second networks may be the same as or different from one another. For example, referring to FIGS. 3B and 3C, the service server may compare the card_code field 308 in the payment method information 300c received from the user terminal and the card_code field 308 in the payment method information 300b stored in the service server.

In step 630, the service server determines at least one third payment method based on the result of the comparison. The service server classifies the received third payment method information as matching the stored fourth payment method information (for example, if the received third payment method information is the same as the fourth payment method information), and determines at least one payment method to be recommended to the user based on a predetermined standard. Examples of the predetermined standard include a financial standard such as a high discount rate, a user purchase standard, and a payment pattern standard, but are not limited thereto since the predetermined standard may differ according to a recommendation policy. Referring to FIGS. 3B and 3C, when the card_code field 308 in the payment method information 300c including the third payment method information and the card_code field 306 in the payment method information 300b including the fourth payment method information are the same as one another, the user terminal classifies the third payment method information, analyzes the card_benefit field 307 corresponding to the card_code field 306, and recommends at least one third payment method according to the predetermined standard.

In step 640, the service server transmits determined third payment method recommendation information to the user terminal. According to an embodiment of the present invention, the service server may directly transmit the third payment method recommendation information to the user terminal through the first network. In another embodiment of the present invention, the service server may transmit the third payment method recommendation information to the device related to the corresponding store through the second network, and the device related to the corresponding network may transmit the third payment method recommendation information to the user terminal through the wireless transceiver. According to another embodiment of the present invention, the service server may transmit the third payment method recommendation information to the device related to the corresponding store through the second network, and the device related to the corresponding store may directly transmit the third payment method recommendation information to the user terminal through the third network instead of through the wireless transceiver.

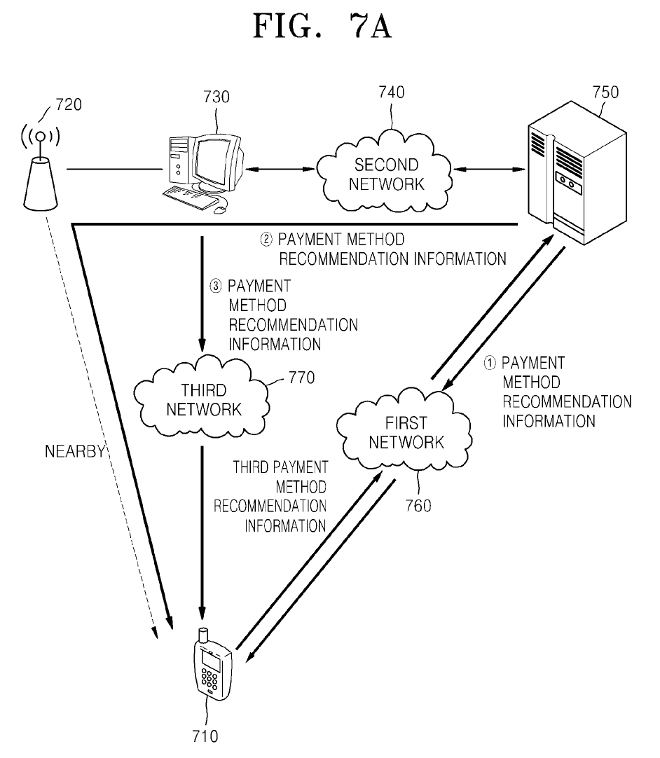

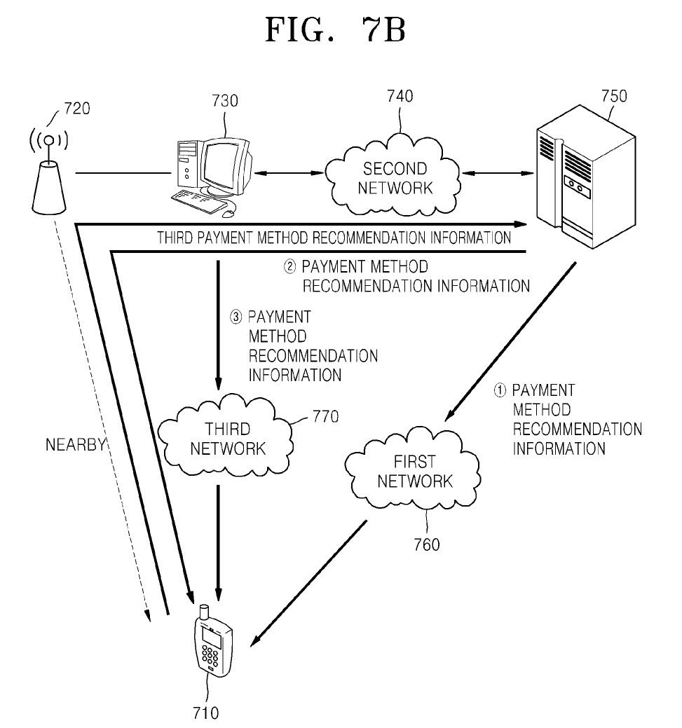

FIGS. 7A and 7B are diagrams illustrating a method of determining and transmitting recommended payment method information to a user terminal 710, which is performed by a service server 750, according to embodiments of the present invention. The method will now be described with reference to FIGS. 7A, 7B, and 5.

Referring to FIG. 7A, when the user terminal 710 is in close proximity to a wireless transceiver 720, a device 730 related to a corresponding store and connected to the wireless transceiver 720 notifies the service server 750 that the user terminal 710 is connected through a second network 740. The user terminal 710 then directly transmits the third payment method information to the service server 750 through a first network 760. The service server 750 then determines third payment method recommendation information for a user by comparing the received third payment method information and pre-stored fourth payment method information. The service server 750 next transmits the third payment method recommendation information to the user terminal 710. According to an embodiment of the present invention, the service server 750 may directly transmit the third payment method recommendation information to the user terminal 710 through the first network 760. According to another embodiment of the present invention, the service server 750 may transmit the third payment method recommendation information to the device 730 through the second network 740, and the device 730 may transmit the third payment method recommendation information to the user terminal 710 through the wireless transceiver 720. According to another embodiment of the present invention, the service server 750 may transmit the third payment method recommendation information to the device 730 through the second network 740, and the device 730 may directly transmit the third payment method recommendation information to the user terminal 710 through a third network 770.

For example, referring to FIG. 5, the user terminal 710 transmits the second payment method information 520, i.e., the third payment method information to the service server 750 through the first network 760. The second payment method information 520 includes the card_code information 521 and the card_serial information 522. The service server 750 then compares the second payment method information 520 and the first payment method information 510, i.e., the fourth payment method information. The first payment method information 510 includes the card_code information 511 and the card_benefit information 512. Corresponding payment methods from among the card_code information 511 of the first payment method information 510 and the card_code information 521 of the second payment method information 520 may be a 0007 card, a 0002 card, and a 0009 card. A payment method that does not correspond but is available may be a 0100 coupon. The service server 750 classifies the third payment method information and generates the third payment method recommendation information for the user based on the predetermined standard. Examples of the third payment method recommendation information, i.e., the recommendation list 530, includes the recommendation list 532 recommended to the user with the recommendation priority 531 based on a high discount rate. For example, the service server 750 generates the third payment method recommendation information by prioritizing the 0007 card since the 0007 card has the highest discount rate of 15%. The service server 750 may then transmit the third payment method recommendation information directly to the user terminal 710 through the first network 760, or to the device 730 through the second network 740 so that the device 730 transmits the third payment method recommendation information to the user terminal 710 through the wireless transceiver 720 or third network 770.

Alternatively, referring to FIG. 7B, when the user terminal 710 is in close proximity to the wireless transceiver 720, the device 730 connected to the wireless transceiver 720 notifies the service server 750 that the user terminal 710 is connected through the second network 740. The user terminal 810 then transmits the third payment method information to the device 730 through the wireless transceiver 720, and the device 730 transmits the third payment method information to the service server 750 through the second network 740. The service server 750 then generates the third payment method recommendation information for the user by comparing the received third payment method information and the pre-stored fourth payment method information. Then, the service server 750 transmits the third payment method recommendation information to the user terminal 710. The service server 750 may directly transmit the third payment method recommendation information to the user terminal 710 through the first network 760. According to another embodiment of the present invention, the service server 750 may transmit the third payment method recommendation information to the device 730 through the second network 740, and the device 730 may transmit the third payment method recommendation information to the user terminal 710 through the wireless transceiver 720. According to another embodiment of the present invention, the service server 750 may transmit the third payment method recommendation information to the device 730 through the second network 740, and the device 730 may directly transmit the third payment method recommendation information to the user terminal 710 through the third network 770. For example, referring to FIG. 5, the user terminal 710 transmits the second payment method information 520, i.e., the third payment method information to the device 730 through the wireless transceiver 720, and the device 730 transmits the second payment method information 620 to the service server 750. The service server 750 generates and transmits the third payment method recommendation list, i.e., the recommendation list 530, to the user terminal 710 as described in FIG. 7A.

After payment method recommendation information is provided to a user, the user may select one of payment methods based on the payment method recommendation information. A user terminal transmits card_serial information (522 of FIG. 5) indicating a card number of the selected payment method included in payment method information stored in the user terminal to an external payment server for electronic payment. If the selected payment method is a point card, the user terminal transmits the card_serial information to an external alliance service server, which provides an alliance service related to a card so that points are decreased or increased. The external alliance service server transmits the result to a service server, and the service server stores the result.

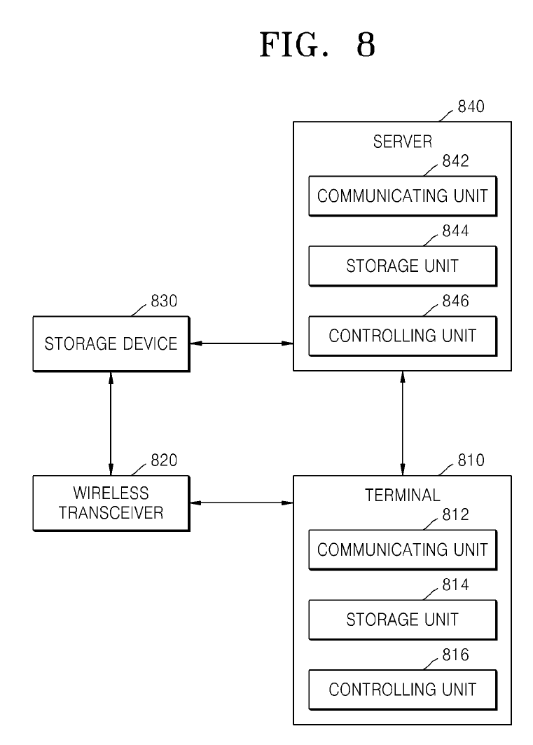

FIG. 8 is a block diagram of a system for providing a transaction related service, according to an embodiment of the present invention.

Referring to FIG. 8, the system includes a terminal 810, a wireless transceiver 820, a storage device 830, and a server 840. The wireless transceiver 820 is capable of proximity communication with the terminal 810, and is connected to the storage device 830. Moreover, the wireless transceiver 820 may communicate with the server 840. The storage device 830 denotes a device related to a corresponding store. The storage device 830 and the server 840 are connected to one another via a predetermined network. The storage device 830 and the wireless transceiver 820 may be integrally formed. The terminal 810 and the server 840 are connected to one another via a predetermined network. Further, the terminal 810 includes a communicating unit 812, a storage unit 814, and a controlling unit 816, and the server 840 includes a communicating unit 842, a storage unit 834, and a controlling unit 836.

An embodiment of the present invention in which the terminal 810 compares and recommends at least one payment method will now be described.

The communicating unit 812 of the terminal 810 receives at least one first payment method information applicable (usable or payable) to the corresponding store from the server 840 through a first network (not shown) including wired communication and wireless communication. The server 840 is pre-connected to the storage device 830 through a second network (not shown) including at least one of wired communication and wireless communication, and pre-stores payment method information usable in the corresponding store in the storage unit 844 of the server 840.

An example of the first payment method information includes information related to a card for replacing a thing having an exchangeable value, such as a credit card, a membership card, a mileage card, a point card, a coupon, a ticket, a voucher, an invitation ticket, or the like (hereinafter, referred to as a card), but is not limited thereto. The server 840 may pre-receive and store the first payment method information from the storage device 830, or may pre-receive and store the first payment method information from a related external server (not shown). Examples of the first payment method information and second payment method information that will be described later are shown in FIGS. 3A through 3C.

When the terminal 810 is in close proximity to the wireless transceiver 820 connected to the server 840, the terminal 810 may receive the first payment method information from the server 840. For example, the wireless transceiver 820 may be an AP. According to an embodiment of the present invention, examples of a method of realizing proximity communication between the terminal 810 and the wireless transceiver 820 include WiFi, Bluetooth, and a method of using any beacon sensor, but the examples are not limited thereto. When the terminal 810 is within a tolerance field of the wireless transceiver 820, the wireless transceiver 820 may recognize the terminal 810 via a predetermined determination process. For example, when an AP including the wireless transceiver 820 is a passive type AP which performs a passive-scanning, the AP transmits a beacon, the terminal 810 transmits an authentication request to the AP upon receiving the beacon, and the AP transmits an authentication response to the terminal 810. Then, the terminal 810 transmits an association request to the AP, and the AP transmits an association response to the terminal 810, and thus the terminal 810 and the AP are connected to one another. When the AP including the wireless transceiver is an active type AP which performs an active-scanning, the terminal 810 transmits a probe request to the AP and the AP transmits a probe response, and thus the terminal 810 and the AP are connected to one another via authenticating and connecting processes. The AP and the terminal 810 may be connected to one another by the storage device 830 connected to the AP. When the terminal 810 and the AP are connected to one another, the wireless transceiver 820 and/or the storage device 830 transmits information about the presence of the terminal 810 to the server 840. When the server 840 recognizes the presence of the terminal 810, the server 840 transmits the first payment method information to the terminal 810 through the first network. Alternatively, when the server 840 recognizes the presence of the terminal 810, instead of directly transmitting the first payment method information to the terminal 810 through the first network, the server 840 transmits the first payment method information to the storage device 830, and the storage device 830 may transmit the first payment method information through the wireless transceiver 820.

Alternatively, upon receiving the first payment method information from the server 840, the storage device 830 may directly transmit the first payment method information to the terminal 810 through a third network (not shown) including wired communication and wireless communication networks, instead of through the wireless transceiver 820. The third network may be the same as or different from the first or second network.

The controlling unit 816 of the terminal 810 compares the received first payment method information and at least one second payment method information available for the user. The second payment method information is payment method information usable by the user, and is stored in the storage unit 814 of the terminal 810. The second payment method information may be stored in the storage unit 814 of the terminal 810 by being directly input by the user or by being received from an external server (not shown) related to a payment method.

The controlling unit 816 of the terminal 810 recommends at least one second payment method based on a result of the comparison. The controlling unit 816 of the terminal 810 classifies the second payment method information as matching the first payment method information (for example, the same as the first payment method information), and recommends at least one second payment method to the user according to a predetermined standard. The controlling unit 816 of the terminal 810 may display the recommended second payment method to the user through a display (not shown) of the terminal 810. Examples of the predetermined standard include a financial standard such as a high discount rate, a user purchase standard, and payment pattern standard, but the examples are not limited thereto since the predetermined standard may differ according to a recommendation policy. Alternatively, the terminal 810 may recommend a second payment method with priority.

Another embodiment of the present invention where the server 840 compares and recommends at least one payment method will now be described.

The communicating unit 842 of the server 840 receives a third payment method information available for the user from the terminal 810. The third payment method information is the same as the second payment method information in the previous embodiment, and examples of the third payment method information are the same as those described above, and, thus, details thereof will be omitted. The third payment method information is stored in the terminal 810 by being directly input by the user or by being received from the external server related to a payment method.

When the terminal 810 is in close proximity to the wireless transceiver 820 connected to the server 840, the server 840 may receive the third payment method information from the terminal 810. For example, the wireless transceiver 820 may be an AP connected to the storage device 830. Examples of a method of communication between the terminal 810 and the wireless transceiver 820 include WiFi, Bluetooth, and a method of using any beacon sensor, but are not limited thereto. When the terminal 810 is within a tolerance field of the wireless transceiver 820, the wireless transceiver 820 may recognize the terminal 810 via a predetermined determination process. For example, when an AP is a passive type AP which performs a passive-scanning, the AP transmits a beacon, the terminal 810 transmits an authentication request to the AP upon receiving the beacon, and the AP transmits an authentication response to the terminal 810. Then, the terminal 810 transmits an association request to the AP, and the AP transmits an association response to the terminal 810, and thus the terminal 810 and the AP are connected to one another. When the AP is an active type AP which performs an active-scanning, the terminal 810 transmits a probe request to the AP and the AP transmits a probe response, and thus the terminal 810 and the AP are connected to one another via authenticating and connecting processes. The AP and the terminal 810 may be connected to one another by the storage device 830 connected to the AP. When the terminal 810 and the AP are connected to one another, the terminal 810 transmits the third payment method information to the server 840 through the wireless transceiver 820 and/or the storage device 830. Alternatively, when the terminal 810 and the AP are connected to one another, the terminal 810 may transmit the third payment method information directly to the server 840 through a first network (not shown) including at least one of wired communication and wireless communication.

The controlling unit 846 of the server 840 compares the received third payment method information and at least one fourth payment method information applicable to the corresponding store. The server 840 is pre-connected to the storage device 830, and pre-stores the fourth payment method information the same as the first payment method information in the previous embodiment. The server 840 may pre-receive and store the fourth payment method information from the storage device 830, or from an external server (not shown) related to the fourth payment method information. The server 840 is connected to the storage device 830 through a second network (not shown) including at least one of wired communication and wireless communication. Here, the first and second networks may be the same as or different from one another.

The controlling unit 846 of the server 840 determines a third payment method based on a result of the comparison. The controlling unit 846 of the server 840 classifies the third payment method information as matching the fourth payment method information (for example, the same as the fourth payment method information), and determines third payment method recommendation information to be recommended to the user based on a predetermine standard. Examples of the predetermined standard include a financial standard such as a high discount rate, a user purchase standard, and a payment pattern standard, but the examples are not limited thereto since the predetermined standard may differ according to a recommendation policy.

The controlling unit 846 of the server 840 transmits the determined third payment method recommendation information to the terminal 810. According to an embodiment of the present invention, the server 840 may directly transmit the third payment method recommendation information to the terminal 810 through the first network. According to another embodiment of the present invention, the server 840 transmits the third payment method recommendation information to the storage device 830 through the second network, and the storage device 830 transmits the third payment method recommendation information to the terminal 810 through the wireless transceiver 820. According to another embodiment of the present invention, the server 840 transmits the third payment method recommendation information to the storage device 830 through the second network, and the storage device 830 transmits the third payment method recommendation information to the terminal 810 through the third network instead of through the wireless transceiver 820. After the third payment method recommendation information is provided to the user, the user may select one of payment methods based on the third payment method recommendation information. Here, the terminal 810 transmits card_serial information (522 of FIG. 5) indicating a card number of the selected payment method from payment method information stored in the terminal 810 to an external payment server (not shown) for electronic payment. If the selected payment method is a point card, the terminal 810 transmits the card_serial information to an external alliance service server (not shown) so that points are decreased or increased. The external alliance service server transmits the result to the server 840, and the server 840 stores the result.

The invention can also be embodied as computer readable codes on a computer readable recording medium. The computer readable recording medium is any data storage device that can store data which can be thereafter read by a computer system. Examples of the computer readable recording medium include Read-Only Memory (ROM), Random-Access Memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While this invention has been particularly shown and described with reference to embodiments thereof, it will be understood by those of ordinary skill in the art that various changes in form and details may be made therein without departing from the spirit and scope of the invention as defined by the appended claims and their equivalents.

What is claimed is:

1. A method for providing a transaction related service, the method comprising:
receiving, from a first device, first payment method information applicable to a corresponding store;
comparing the first payment method information and second payment method information available for a user; and
recommending the second payment method based on a result of the comparing.

2. The method of claim 1, wherein, when a user terminal is in close proximity to a second device connected to the first device, receiving the first payment method information applicable to the corresponding store from the first device.

3. The method of claim 2, wherein the second device is a wireless transceiver within a predetermined distance of the corresponding store.

4. The method of claim 2, wherein, when the user terminal is in close proximity to the second device connected to the first device, receiving the first payment method information applicable to the corresponding store from the first device through the second device.

5. The method of claim 1, wherein the second payment method information is user owned card information.

6. The method of claim 1, wherein the second payment method information is received from a third external device related to the second payment method information.

7. The method of claim 1, wherein the first payment method information is discount information related to the corresponding store.

8. The method of claim 1, wherein recommending the second payment method occurs according to a financial standard based on the result of the comparing.

9. The method of claim 1, wherein recommending the second payment method occurs according to a user purchase pattern based on the result of the comparing.

10. A method of providing a transaction related service, the method comprising:
receiving first payment method information available for a user from a first device;
comparing the first payment method information and second payment method information applicable to a corresponding store; and
recommending the first payment method based on a result of the comparing.

11. The method of claim 10, wherein, when a user terminal is in close proximity to a second device connected to the first device, receiving the first payment method information available for the user from the first device.

12. The method of claim 11, wherein the second device is a wireless transceiver within a predetermined distance of the corresponding store.

13. The method of claim 11, wherein, when the user terminal is in close proximity to the second device connected to the first device, receiving the first payment method information available for the user from the first device through the second device.

14. The method of claim 10, wherein the first payment method information is user owned card information.

15. The method of claim 10, wherein recommending comprises recommending the first payment method according to a financial standard based on the result of the comparing.

16. The method of claim 10, wherein recommending comprises recommending the first payment method according to a user purchase pattern based on the result of the comparing.

17. An apparatus for providing a transaction related service, the apparatus comprising:
a communicating unit for receiving first payment method information applicable to a corresponding store from a first device;
a storage unit for storing second payment method information available for a user;
a controlling unit for recommending the second payment method based on a result of comparing the first payment method information and the second payment method information.

18. The apparatus of claim 17, wherein, when a user terminal is in close proximity to a second device connected to the first device, the communication unit receives the first payment method information applicable to the corresponding store from the first device.

19. The apparatus of claim 18, wherein the second device is a wireless transceiver within a predetermined distance from the corresponding store.

20. The apparatus of claim 18, wherein, when the user terminal is in close proximity to the second device connected to the first device, the communication unit receives the first payment method information applicable to the corresponding store from the first device through the second device.

21. The apparatus of claim 17, wherein the second payment method information is user owned card information.

22. The apparatus of claim 17, wherein the second payment method information is received from a third external device related to the second payment method information.

23. The apparatus of claim 17, wherein the first payment method information is discount information related to the corresponding store.

24. The apparatus of claim 17, wherein the controlling unit recommends the second payment method according to a financial standard based on the result of the comparing.

25. The apparatus of claim 17, wherein the controlling unit recommends the second payment method according to a user purchase pattern based on the result of the comparing.

26. An apparatus for providing a transaction related service, the apparatus comprising:
a communicating unit for receiving first payment method information available for a user from a first device;
a storage unit for storing second payment method information applicable to a corresponding store; and
a controlling unit for recommending the first payment method based on a result of comparing the first payment method information and the second payment method information.

27. The apparatus of claim 26, wherein the communicating unit receives the first payment method information available for the user from the first device when a user terminal is in close proximity to a second device connected to the first device.

28. The apparatus of claim 27, wherein the second device is a wireless transceiver within a predetermined distance from the corresponding store.

29. The apparatus of claim 27, wherein, when the user terminal is in close proximity to the second device connected to the first device, the communicating unit receives the first payment method information available for the user from the first device through the second device.

30. The apparatus of claim 26, wherein the first payment method information is user owned card information.

31. The apparatus of claim 26, wherein the controlling unit recommends the first payment method according to a financial standard based on the result of the comparing.

32. The apparatus of claim 26, wherein the controlling unit recommends the first payment method according to a user purchase pattern based on the result of the comparing.

33. A computer readable recording medium having recorded thereon a program for executing a method of providing a transaction related service, the method comprising:
receiving first payment method information applicable to a corresponding store from a first device;
comparing the first payment method information and a second payment method information available for a user; and
recommending the second payment method based on a result of the comparing.

34. A computer readable recording medium having recorded thereon a program for executing a method of providing a transaction related service, the method comprising:
receiving first payment method information available for a user from a first device;
comparing the first payment method information and second payment method information corresponding to a store; and
recommending the first payment method based on a result of the comparing.
